(19) United States
(12) Patent Application Publication
(10) Pub. No.: US 2007/0013093 A1
(43) Pub. Date: Jan. 18, 2007

(54) Apparatus and process for the production of green ceramic preforms

(76) Inventor: Heinz Lambrecht, Bremen (DE)

Correspondence Address: BROMBERG & SUNSTEIN LLP, 125 SUMMER STREET, BOSTON, MA, 02110-1618, US

(21) Appl. No.: 11/487,150

(22) Filed: Jul. 14, 2006

(30) Foreign Application Priority Data
Jul. 15, 2005 (DE) 102005033140.8-23

(51) Int. Cl. A61C 13/00; B29C 41/14; B28B 1/38

(52) U.S. Cl. 264/16; 264/301; 249/54; 425/175

(57) ABSTRACT

A process for the production of green ceramic preforms for dental parts involves introducing a model into ceramic slip in a slip container for coating the model. Ceramic slip is controllably drawn off from the slip container and the coated model removed. An apparatus for producing green ceramic preforms includes an opening in the slip container through which flow of the ceramic slip is controllable. The green ceramic preform may be used to produce a dental part. Conduit means are so arranged on the slip container that ceramic slip can be controlledly drawn off out of the slip container through the conduit means.

### CROSS REFERENCE TO RELATED APPLICATIONS

This application claims priority from German Patent Application 10 2005 033 140.8-23 DE filed Jul. 15, 2005, the full disclosure of which is hereby incorporated by reference herein.

### BACKGROUND OF THE INVENTION

The invention concerns an apparatus and a process for the production of green (unsintered) ceramic preforms for dental parts, and a process for the production of dental parts.

Processes for the production of green ceramic preforms for dental parts are known, in which a shaping stump of a working model is dipped for coating with ceramic slip into a slip container containing such a slip, for example from DE 100 02 921 A1, DE 100 21 437 A1, DE 101 27 144 A1, DE 102 51 369 A1 and DE 104 34 437 A1.

The term ‘coating with ceramic slip’ signifies in the context of this text that the ceramic base material, for example ceramic powder, which is contained in the form of a suspension in a suspension agent, for example water, is applied in solid form as a coating to a substrate. The coating resulting therefrom therefore includes ceramic base material and possibly portions of suspension agent. That coating represents a green ceramic preform.

The operation of applying the coating can be effected for example by local destabilisation of the slip, by a removal of liquid by way of the porous stump material and/or by way of electrophoretic deposit.

In order to improve the coating procedure DE 100 21 437 A1 proposes applying a dc voltage between (a) the stump to be coated and (b) the ceramic slip or the slip container containing the ceramic slip, in order to provide for electrophoretic deposit. The deposit rate is not linear in all three processes and decreases with increasing layer thickness. The layer thicknesses for ceramic crowns are preferably in the range of 0.4 mm to 1.0 mm and for intermediate bridge members they are in the range of 1.0 mm to 4.0 mm. The layer thickness is adjusted in that situation by a suitable choice for the coating parameters such as time and/or voltage and/or current strength.

What is common to the known processes and the apparatuses used in that respect is that the shaping stump is dipped into the ceramic slip. In that case either the shaping stump is moved into the slip container or the slip container is moved in order to receive the shaping stump. Upon removal from the ceramic slip bath relative movement between the shaping stump and the slip container again takes place.

Withdrawing the shaping stump from the ceramic slip is crucial in terms of a desired uniform layer thickness. If the shaping stump is withdrawn from the ceramic slip excessively rapidly the film of liquid which still clings thereto can be pulled off. The liquid which is still clinging thereto then collects in the form of drops at a lower end of the shaping stump, and that results in an irregular coating. If in contrast the shaping stump is removed from the slip sufficiently slowly, no drop or only a very small drop is formed, and that leads to a more uniform coating.

The higher the respective viscosity and surface tension of the slip, the correspondingly slower should the object be dipped into the slip and removed therefrom again. In that case the limit speeds are usually between 0.1 mm/s and 1 mm/s, in which respect it was only possible to set speeds above 0.27 mm/s with the processes and apparatuses known hitherto.

If the shaping stump is introduced into the ceramic slip bath excessively quickly, that can have detrimental effects on the coating. In particular, if shaping stumps with a deep occlusal fossa (cavity), in particular in the case of lateral tooth stumps, are dipped into the bath excessively quickly, unwanted air inclusions can occur.

The layer thickness or wall thickness of the coating derives from the combination of the deposit rate and the residence time in the ceramic slip bath, in which respect introduction into the ceramic slip bath and removal therefrom are to be taken into consideration.

In practice an automatic linear guide has been used hitherto for removal of the coated shaping stump from the ceramic slip bath. Such an automatic linear guide however is complicated and expensive and sensitive in relation to variations in parameters.

### SUMMARY OF THE INVENTION

Therefore an object of embodiments of the present invention is to propose an apparatus and a process which avoid the disadvantages of the conventional apparatuses and processes and which in a simple manner permit controlled removal of the coated shaping stump or another coated shaping means (for example a coated metal foil or an outer (negative) mould coated from the interior for producing a bridge member) from the ceramic slip bath.

In accordance with an embodiment of the invention, an apparatus for the production of green ceramic preforms for dental parts includes a first slip container, wherein a model (defined herein as including for example, a positive model of a tooth stump, a shaping stump, a shaping means, a core or a negative mold for the production of a bridge intermediate member) can be introduced into the ceramic slip for coating with ceramic slip to produce a green ceramic preform, which includes (a) ceramic slip in the first slip container and/or (b) a voltage supply connection for electrophoretic deposit, wherein (in accordance with both alternatives (a) and (b)) conduit means (simple examples of which include a drain opening, or a piping, a tube, or a hose connected to an opening of the slip container) are so arranged on the first slip container that ceramic slip can be drawn off out of the first slip container controlledly through the conduit means.

The object is also attained by a process for the production of green ceramic preforms for dental parts comprising the following steps:
introducing a ceramic slip bath into a first slip container of an apparatus,
dipping a model, in particular a shaping stump or a mold into the ceramic slip bath in the first slip container,
coating the model with ceramic slip in the ceramic slip bath so that a green ceramic preform is produced, and
drawing off ceramic slip from the first slip container controlledly for removal of the model from the ceramic slip bath.

In accordance with embodiments of the invention it is realized that the model can be removed from the ceramic slip bath without moving the model or the apparatus containing the ceramic slip, by the surface of the ceramic slip bath (the level of the slip) being controlledly lowered. Instead of the relative movement linked to the removal of a coated shaping stump being produced as hitherto by the model (e.g. the shaping stump) being moved relative to the apparatus (in relation to which the level of slip substantially remains unchanged in accordance with the previous procedure), the model and the apparatus can retain their position relative to each other if the level of slip is lowered in relation to the apparatus and thus the model by controlledly letting out ceramic slip. Control of the operation of letting out ceramic slip and control of the speed at which the level of slip falls can be achieved with means which are simpler than those which were used hitherto in practice for controlling the removal of a coated model. The first slip container which is filled with ceramic slip is emptied at a respective emptying speed which results for example from the viscosity of the ceramic slip and the size of the opening of the drain, it is possible to achieve different layer thicknesses, while unwanted drop formation is avoided.

In a preferred configuration of the apparatus according to the invention the conduit means includes a drain opening for drawing off ceramic slip in the lower region of the first slip container. As a consequence of the force of gravity ceramic slip flows away out of the first slip container in a simple fashion. No additional means such as for example a pump are required, only the drain opening itself has to be controlled, for example in respect of its size, to achieve a controlled draw-off effect. The size of the drain opening is preferably in a range which corresponds to the size of a circle of a diameter in the range of 1 to 10 mm, preferably in the range of 2 to 4 mm. Drain opening shapes differing from a circular shape are possible but the circular shape is preferred. The size of the drain opening and the viscosity of the slip jointly govern the through-flow rate so that the two parameters should be suitably adjusted relative to each other.

The conduit means may further include a mechanical slider or a squeeze valve suitable for that purpose in a particularly simple fashion, with which the drain opening of the first slip container is closable for controlledly draining ceramic slip out of the first slip container.

In an advantageous configuration the apparatus according to the invention includes a second slip container into which ceramic slip can be controlledly introduced through the conduit means from the first slip container. By virtue of the ceramic slip which is drained off being caught it remains in the apparatus and can be re-used at a later time. In that respect advantageously all internal spaces of the first and the second slip containers are connected together by the drain opening and are separable from each other by a slider, plug, barrier, valve or other means for closing the drain opening.

In accordance with a further configuration there are provided one or more openings at a location remote from the drain opening in the first and/or the second slip container, and closure covers for releasably sealing closed the opening or openings. An opening affords the possibility of entering the internal space of a slip container, for example for repairs or for cleaning purposes, while the closure covers prevent unwanted escape of ceramic slip at least in operation.

Advantageously, an introduction passage may be included by which ceramic slip can be introduced from the second slip container into the first slip container. In that way it is possible for ceramic slip which was drained out of the first slip container into the second slip container to be passed back into the first slip container again. The introduction passage may be included in the conduit means, e.g. by providing a conduit connecting first and second slip container through which ceramic slip might be conveyed in both directions.

In accordance with a further preferred configuration of the apparatus according to the invention the first and second slip containers are of substantially the same structural configuration and can exchange their position by a rotary movement about a horizontal axis. If ceramic slip were drawn off out of the first slip container into the second, then with that configuration the apparatus can be turned upside down, in which case the first and the second slip containers exchange their positions and functions. In that way the time required for ceramic slip to be transferred back from the second slip container into the first slip container can be saved and it is possible to dispense with additional means for returning ceramic slip from the second slip container to the first slip container.

In addition the second slip container and/or the closure cover of the second slip container can have an agitator for agitating ceramic slip, whereby it is possible to avoid unwanted separation of ceramic base material and suspension agent.

Equally the first slip container and/or the closure cover of the first slip container can have fixing means for releasably fixing the position of the model, e.g. the shaping stump. As a relative movement between the apparatus and the model is neither necessary during the coating operation, nor for removal of the model from the ceramic slip bath, there is preferably provided a suitable holder for the model in the first slip container or at the closure cover thereof. In that way, the model can be fixed at times at a predetermined position in the interior of the slip container and thus in the ceramic slip bath.

In a further configuration of the invention, the internal space of the first slip container decreases towards the drain opening. With a cross-section which decreases accordingly towards the drain opening, it can be provided that the speed at which the level of slip falls can be kept substantially constant even when there is a reduced filling height of the ceramic slip in the first slip container.

In a further configuration of the apparatus it has a third slip container, also having an opening such that ceramic slip can be introduced controlledly from the third slip container into the first slip container through the opening. The controlled introduction of ceramic slip from the third slip container into the first slip container provides that it is not only removal from the ceramic slip bath that takes place at a desired predetermined speed, but also introduction into the ceramic slip bath, without the model having to be moved relative to the apparatus.

In an advantageous configuration of the process according to the invention, it is provided that the coating operation is effected by (i) electrophoretic deposit, (ii) destabilisation of ceramic slip and/or (iii) in the case of a porous shaping stump or a porous outer mould removal of the liquid phase from the ceramic slip by virtue of the porosity.

Such process configurations mean that the coating operation can be speeded up, which leads to shorter processing times without the quality of the coating and thus the green ceramic preform produced suffering therefrom.

Preferably the model is coated with an electrolyte for destabilisation of the ceramic slip prior to being dipped into the ceramic slip bath. In this case salts, certain tensides or pH value-altering substances are used as the electrolyte coating, with salts being preferred.

A process according to the invention for the production of a dental part, in particular an inlay, a crown, a bridge or an implant support, comprises the steps:
providing a model like a shaping stump or a mold,
producing a green ceramic preform on the model in accordance with a process according to the invention, and
producing the dental part from the green ceramic preform.

In the process according to the invention the green ceramic preform is produced in a simple and inexpensive manner, wherein after production of the green ceramic preform by the coating on the shaping means the preform is usually separated from the model before the dental part is produced therefrom, for example by sintering, possibly linked with glass infiltration.

### BRIEF DESCRIPTION OF THE DRAWINGS

FIG. 1a shows a diagrammatic cross-sectional view of a first embodiment of the apparatus according to the invention prior to drawing off ceramic slip,

FIG. 1b shows a diagrammatic cross-sectional view of the first embodiment of FIG. 1a after drawing off ceramic slip,

FIG. 2 shows a diagrammatic cross-sectional view of a second embodiment of the apparatus according to the invention,

FIG. 3 shows a diagrammatic cross-sectional view of a third embodiment of the apparatus according to the invention,

FIG. 4a shows a diagrammatic side view of a fourth embodiment of the apparatus according to the invention, and

FIG. 4b shows a diagrammatic cross-sectional view of the fourth embodiment shown in FIG. 4a.

### DETAILED DESCRIPTION OF SPECIFIC EMBODIMENTS

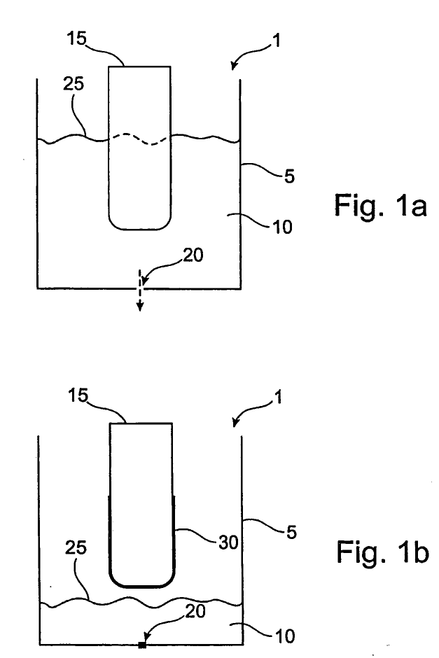

FIG. 1a shows a diagrammatic cross-sectional view of a first embodiment of the apparatus 1 according to the invention before the operation of drawing off ceramic slip 10 disposed in a first slip container 10. A model, such as shaping stump 15, is dipped into the ceramic slip bath formed by the ceramic slip 10. The shaping stump may be any workpiece dipped for coating with ceramic slip. In a particular embodiment, the shaping stump is a positive model of a tooth stump. Alternatively, the model may be a negative mold, such as used for the production of a bridge intermediate member. In its lower region, the first slip container 10 has conduit means in the form of a drain opening 20 through which ceramic slip can be controlledly drawn out of the first slip container 10. The drain opening 20 is shown here in the open condition, in which case ceramic slip can flow away out of the first slip container whereby the level of slip 25 falls in relation to the first slip container. The drain opening 20 controls the flow of the ceramic slip, as a function of the size of the opening, the force of gravity and the viscosity of the slip.

As long as a part of the shaping stump 15 is in the ceramic slip bath, ceramic base material is deposited thereon from the ceramic slip 10. A possible way of promoting such a coating involves making the material of the shaping stump 15 of a porous nature (not shown) in such a way that the suspension agent of the ceramic slip 10 is absorbed by the shaping stump 15, with the ceramic base material then remaining at the outside of the shaping stump 15. The shaping stump 15 can alternatively also be provided with a destabilisation agent (not shown), for example an electrolyte material, which causes the ceramic slip 10 to be destabilised, that is to say the slip 10 experiences separation of suspension agent and ceramic base material, with the ceramic base material being deposited on the shaping stump. The shaping stump comprises a pourable material, preferably plaster.

FIG. 1b shows a diagrammatic cross-sectional view of the first embodiment from FIG. 1a after ceramic slip 10 is drawn off. Ceramic slip 10 is let out of the apparatus 1 or the first slip container 5, starting from the situation illustrated in FIG. 1a, so that the level of slip 25 has fallen in such a way that the shaping stump 15 is no longer in the ceramic slip bath. The drain opening 20 is illustrated closed here so that no further ceramic slip 10 is drawn off from the first slip container 5 through the drain opening. During the residence time in the ceramic slip bath, a coating 30 is applied to the surface of the shaping stump 15, the coating 30 containing ceramic base material which is deposited out of the ceramic slip 10. In addition, the coating 30 may also contain a proportion of suspension agent used in the ceramic slip 10. The coating 30 thus represents a green ceramic preform 30 which in known manner can be further processed to provide a dental part, for example by sintering, possibly followed by glass infiltration and optional veneering. In that respect it can be provided that the ceramic preform is separated from the shaping stump 15 prior to further processing in suitable known manner, that is done only after one or more processing steps, or the shaping stump 15 is also left in the ceramic material.

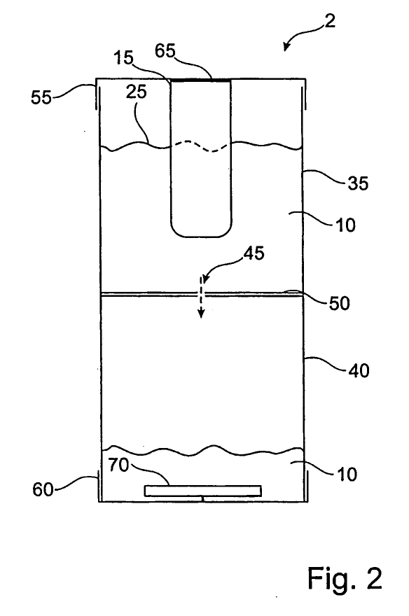

FIG. 2 shows a diagrammatic cross-sectional view of a second embodiment of the apparatus 2 according to the invention. The apparatus 2 has a first slip container 35, the internal space of which is communicated by way of a conduit means in the form of a drain opening 45 in its lower region with the internal space of a second slip container 40 arranged beneath the first slip container 35. Ceramic slip 10 is disposed in the apparatus 2. In the embodiment illustrated here the slip containers 35, 40 have a common wall 50 in which the conduit means includes drain opening 45 along with suitable means (not shown) for adjustably controlling the drain opening, for example a squeeze valve or a slider. The conduit means may further include mechanical or electronic means for operating the valve or slider to vary the size of the drain opening. The conduit means may rely on gravity or may include a pump or other mechanism for forcing flow through the drain opening. The first slip container 35 has a closure cover 55 at a side opposite to the drain opening 45, here in its upper region. The second slip container 40 also has a closure cover 60 at a side remote from the drain opening 45. The slip containers 35, 40 and the closure covers 55, 60 are so designed that the slip containers 35, 50 can be closed by the closure covers 55, 60 at least in the operating condition in such a way that no ceramic slip 10 can unintentionally escape. The closure cover 55 of the first slip container 35 has fixing means 65 for holding in position a model, such as a shaping stump 15 which is to be coated with ceramic material. The shaping stump 15 is fixed in such a way that at least in part it can extend below a level 25 of the ceramic slip bath into the ceramic slip 10 for coating with ceramic material. In the illustrated embodiment, the shaping stump is fixed in position by a kneading material as a fixing means 65 to the closure cover 55. A large number of other fixing alternatives is possible. For example, if the shaping stump has suitable means such as pins, it can also be fixed by screw clamps. In addition, a suitable adhesive material can be used instead of the kneadable material. The closure cover 60 of the second slip container 40 is provided with an agitator 70. The agitator 70 may be any of a variety of alternatives for agitating ceramic in a container, for example, the agitator 70 can be in the form of a magnetic agitator, a fluid circulation circuit with integrated pump or an ultrasonic device. The agitator may move while the container is kept fixed or the agitator may move the container to agitate the ceramic slip.

The shaping stump 15 fixed to the closure cover 55 is introduced into the ceramic slip bath so that it is possible to provide for coating with ceramic base material, similarly to the first embodiment described hereinbefore. Ceramic slip 10 is drawn off out of the first slip container 35 into the second slip container 40 through the drain opening 45, with the draw-off of slip material being controlled in such a way that the level 25 of the ceramic slip in the first slip container 35 falls at a desired speed and thus the shaping stump 15 is removed from the ceramic slip bath. Expressed another way, the ceramic slip bath is moved away from the shaping stump 15. The ceramic slip 10 which is drawn off into the second slip container 40 is agitated by means of the agitator device, which is intended to prevent the ceramic slip 10 from unintentionally separating into suspension agent and ceramic base material.

When ceramic slip 10 is passed into the second slip container 40 air is displaced out of the second slip container 40. For that purpose it can be provided that the second slip container 40 includes a vent through which the displaced air can be let out so as to prevent, for example, air bubbles entering the first slip container through the drain opening 45. If the first slip container 35 is closed by the closure cover 55 in such a way that no air or the like can pass into the region above the surface 25 of the slip, a reduced pressure is formed as a consequence of the level of slip 25 moving downwardly, and that can have unintentional effects on the rate of downward movement of the level of slip. In order to avoid such a reduced pressure, it can be provided for example that the closure cover 55 does not air-tightly close off the first slip container 35 or the first slip container 35 has other suitable means for pressure equalisation. It can also be provided in that respect that the air displaced out of the second slip container 60 is introduced into the first slip container 35 above the level 25 of slip.

If the first and second slip container 35, 40 and the associated closure covers 55, 60 are of substantially the same structural configuration they can exchange their positions by a rotary movement about a horizontal axis and then each perform the function of the other. It can also be provided that the closure cover 55 of the first slip container 35 is replaced prior to the rotary movement by a further specimen of the closure cover 60 of the second slip container 40 and that, after the rotary movement, the closure cover 55 is placed on the second slip container which is then in the upper region of the apparatus. In that case it is possible to dispense with the two closure covers having both fixing means and also agitator means.

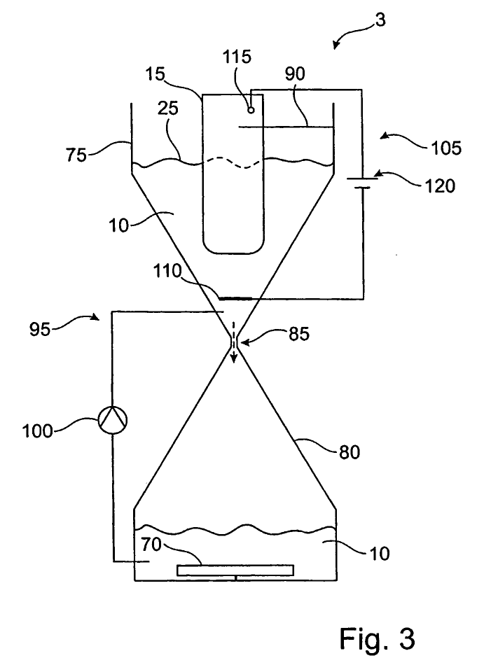

The embodiment of an apparatus 3 according to the invention, as shown in FIG. 3, is similar to the embodiment shown in FIG. 2. The internal spaces of a first and a second slip container 75 and 80 respectively are connected by an outlet opening 85 through which ceramic slip 10 can be introduced from the first upper slip container 75 into the second lower slip container 80. The two slip containers 75, 80 do not have a common wall here as their respective internal space tapers towards the outlet opening 85 arranged between them. The shape is similar to an hourglass. A suitable tapering of the internal space of the first slip container 75 can provide that the discharge speed through the drain opening 85, even with a falling level 25 of slip, is so determined without special control of the drain opening 85 that the level 25 of slip falls at a substantially constant rate. No closure cover is provided here for the first slip container 75, the shaping stump being held with fixing means 90 mounted to the first slip container 75. The second slip container 80 also does not have a closure cover, the container is in that respect closed of itself. An agitator 70 is provided on the closure cover, similarly to the embodiment shown in FIG. 2.

If it is not provided that the first and second slip containers are interchangeable, it is also possible to dispense with the internal space of the second slip container 80 tapering towards the drain opening 85.

The apparatus 3 according to the invention has an introduction passage 95 which is in contact with the internal space of the second slip container 80 in the lower region thereof and in a similar manner is in communication with the internal space of the first slip container 75. Ceramic slip 10 can be introduced into the first slip container 75 from the second slip container 80 through the introduction passage 95. If ceramic slip 10 was passed out of the first slip container 75 into the second slip container 80 after or during the coating operation, then ceramic slip 10 can be introduced into the first slip container again through the introduction passage 95 so that the operation can begin afresh. A pump 100 is provided in the introduction passage 95 in order to overcome the difference in height.

In an alternative configuration (not shown) the introduction passage 95 serves as the conduit means to controlledly draw off ceramic slip from the first slip container, in which case it is possible to dispense with a separate drain opening (85).

Furthermore the apparatus 3 shown in FIG. 3 has an electrophoretic deposit circuit 105. A voltage supply connection of the electrophoretic deposit circuit provides voltage so that current may flow through the electrophoretic deposit circuit 105. The voltage supply connection includes an electrode 110 arranged in the ceramic slip bath, that is to say in direct contact with the ceramic slip 10, and a second electrode 115 in contact with the shaping stump 15, namely the surface thereof which is conducting or which is made conducting. A dc voltage is produced across the electrodes 110, 115 by a dc voltage source 120 in the voltage supply connection. In that situation, the shaping stump 15 in the illustrated embodiment is connected to the positive terminal of the voltage source 120 while the electrode 110 and therewith the ceramic slip 10 are at negative potential. The polarity can also be reversed, depending on the charge of the particles contained in the ceramic slip. The application of a voltage between the shaping stump 15 and the ceramic slip 10 allows electrophoretic deposit of ceramic material on the shaping stump, whereby higher deposit rates can be achieved. Further details relating to electrophoretic deposit out of the ceramic slip can be found for example in laid-open applications DE 100 21 437 A1, DE 102 51 369 A1 and DE 103 34 437 A1.

In addition, the voltage supply connection can include a control (not shown) with which the applied voltage is altered during operation in order to achieve better deposit. Alternatively or in addition, current controls may be incorporated into the electrophoretic deposit circuit.

Besides a main power supply, the voltage source 120 can also be fed by a suitable battery arrangement so that the apparatus becomes independent of a main power supply. It is possible for the battery arrangement and/or the control of the voltage supply connection to be integrated into a closure cover or a cover plate to which the shaping stump (or another shaping means) can also be fixed.

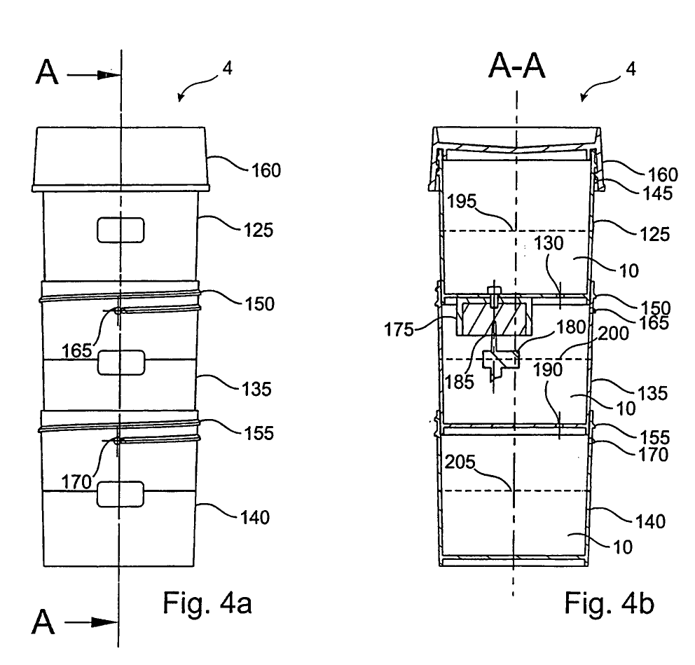

FIGS. 4a and 4b show a diagrammatic side view and a cross-sectional view of a fourth embodiment of the apparatus 4 according to the invention. The apparatus 4 includes a first slip container 135, a second slip container 140 arranged beneath the first slip container 135 and a third slip container 125 arranged above the first slip container 135. In their upper regions, at the outside, the slip containers 125, 135, 140 each have a respective screwthread 145, 150, 155, the third slip container 125 being provided with a closure cover 160 which is held by means of the screwthread 145. The slip containers 125, 135, 140 are of substantially identical dimensions, with the outside region decreasing slightly towards the respective lower end of the slip containers 125, 135, 140. That allows the slip containers 125, 135, 140 to be fitted one into the other and to be connected together in that way. In their respective upper region each of the slip containers 125, 135, 140 has a respective vent bore 165, 170 in its side wall.

FIG. 4b shows a diagrammatic cross-sectional view of the fourth embodiment shown in FIG. 4a. The plane of the drawing in FIG. 4b is perpendicular to that of FIG. 4a, as indicated by the section A-A in FIG. 4a. Arranged in the interior of the first slip container 135 is a kneading material container 175 with kneading material 185. In the embodiment illustrated here the kneading material container 175 is fixed to the bottom of the third slip container 125 which is fitted into the first slip container 135. The shaping stump 180 to be coated is pushed into the kneading material 185 in the kneading material container 175 and thus fixed in place. It can also be provided that the kneading material container is fixed to the first slip container 135 itself or that another suitable way of fixing the shaping stump 180 in the first slip container 135 is adopted.

The bottom of the third slip container 125 has an outlet bore 130. Likewise the bottom of the first slip container 135 has an outlet bore 190.

In operation the amount of ceramic slip 10 necessary for coating the shaping stump 180 is firstly put into the third slip container 125, the closure cover 160 of which is removed for that purpose. The filling level which is firstly reached in the third slip container 125 is indicated by the liquid level 195.

The outlet bore 130 is opened and the ceramic slip 10 is in that way passed at a controlled speed out of the third slip container 125 into the first slip container 135. The air which is displaced out of the first slip container 135 in that situation issues through the vent bore 165.

The outlet bore 190 of the first slip container 135 is admittedly opened but the finger valve 170 of the second slip container 140 is kept closed so that no ceramic slip passes thereinto as no pressure equalisation can take place. The filling condition in the first slip container 135 is as illustrated by the liquid level 200. During the filling procedure the shaping stump 180 is introduced into the ceramic slip bath in the first slip container 135, with the speed of introduction arising out of the feed flow of ceramic slip which can be adjusted by suitably controlled opening of the outlet bore. Thereupon the desired coating is formed on the shaping stump 180, wherein the formation of the coating can be supported by suitable measures, for example local destabilisation of the ceramic slip 10, removal of liquid due to the porosity of the shaping stump and/or electrophoresis. The shaping stump therefore remains in the ceramic slip bath for a predetermined period of time or at least until a desired layer thickness is formed.

After expiry of the time intended for the coating operation, the finger valve 170 is opened so that the ceramic slip 10 is controlledly drawn off through the outlet bore from the first slip container into the second slip container 140. If desired, the finger valve 170 may be used to gradually vary the amount of vent opening so that the rate of flow of the ceramic slip can be further adjusted. The level of liquid in the first slip container 135 falls and the coated shaping stump 180 is controlledly moved out of the ceramic slip bath. At the end of the operation, the filling condition indicated by the liquid level 205 occurs in the second slip container 140, the first and second slip containers 125, 135 being emptied of ceramic slip.

The slip containers can be provided with agitators in order to prevent unintentional separation of ceramic material and suspension agent. As the slip containers are (or can be) simply fitted one into the other, they can also be easily separated again, for example for cleaning purposes. In addition all three slip containers are of substantially the same or similar structural configuration, which simplifies production.

In accordance with embodiments of the invention, the slip container is controlledly emptied of ceramic slip so that the level of slip of a ceramic slip bath for coating a model (such as a shaping stump) with ceramic material falls in the desired manner, in which case the model passes out of the ceramic slip bath, with ceramic material clinging thereto, without a movement of the model relative to the slip container occurring. Discharge of the ceramic slip is easier to control than a relative movement of the model and the slip container so that it is possible to achieve better deposit results.

I claim:

1. Apparatus for producing green ceramic preforms for dental parts, comprising:
a first slip container suitable for receiving ceramic slip and a model into the ceramic slip; and
conduit means arranged on the first slip container for controlling removal of ceramic slip out of the first slip container through the conduit means.

2. Apparatus of claim 1 further comprising a voltage supply connection for electrophoretic deposit of ceramic slip on the model to be coated.

3. Apparatus of claim 1 wherein the conduit means comprises a drain opening in a lower region of the first slip container.

4. Apparatus of claim 3 wherein the conduit means further includes a mechanical slider.

5. Apparatus of claim 3 wherein the conduit means further includes a squeeze valve.

6. Apparatus of claim 1 wherein the conduit means comprises a drain opening and wherein said apparatus further comprises a second slip container arranged to receive ceramic slip that is drawn off through the drain opening from the first slip container.

7. Apparatus of claim 6 further comprising means for closing the drain opening.

8. Apparatus of claim 6 further comprising one or more openings at a location remote from the drain opening in the first and/or the second slip container and one or more removable closure covers for closing the one or more openings.

9. Apparatus of claim 6 further comprising an introduction passage by which ceramic slip can be introduced from the second slip container into the first slip container.

10. Apparatus of claim 6 wherein the first and second slip containers are of substantially the same structural configuration and can exchange their position by a rotary movement about a horizontal axis.

11. Apparatus of claim 6 further comprising an agitator in the second slip container for agitating ceramic slip.

12. Apparatus of claim 1 further comprising means for temporarily fixing the stump in a position within the first slip container.

13. Apparatus of claim 1 wherein the internal space of the first slip container decreases towards the drain opening.

14. Apparatus of claim 6 further comprising a third slip container such that ceramic slip can be introduced controlledly from the third slip container into the first slip container.

15. A process for the production of green ceramic preforms for dental parts comprising:
introducing ceramic slip into a first slip container
dipping a model into the ceramic slip in the first slip container
coating the model with ceramic slip in the ceramic slip bath so that a green ceramic preform is produced;
controllably drawing off ceramic slip from the first slip container; and
removing the model with the green ceramic preform from the first slip container.

16. A process according to claim 15 wherein the coating operation is effected by (i) electrophoretic deposit, (ii) destabilisation of ceramic slip and/or (iii) removal of the liquid phase from the ceramic slip by virtue of a porosity of the model.

17. A process according to claim 16 wherein the model is coated with an electrolyte for destabilisation of the ceramic slip prior to being dipped into the ceramic slip bath.

18. A process according to claim 15 wherein the model is a positive model of a tooth stump.

19. A process for the production of a dental part, comprising the steps:
providing a model;
producing a green ceramic preform on the model in accordance with the process of claim 15; and
producing the dental part from the green ceramic perform.
